(19) United States
(12) Patent Application Publication
(10) Pub. No.: US 2013/0212946 A1
(43) Pub. Date: Aug. 22, 2013

(54) LOUVER ASSEMBLY

(71) Applicant: Jesse Villarreal, JR., Canby, OR (US)

(72) Inventor: Jesse Villarreal, JR., Canby, OR (US)

(21) Appl. No.: 13/762,239

(22) Filed: Feb. 7, 2013

Related U.S. Application Data
(60) Provisional application No. 61/710,550, filed on Oct. 5, 2012.
(60) Provisional application No. 61/596,175, filed on Feb. 7, 2012.

(51) Int. Cl. E06B 7/084

(52) U.S. Cl. CPC E06B 7/084
USPC 49/90.1; 49/506

(57) ABSTRACT

A louver assembly includes a rail including a first rail portion configured to connect to a mounting structure and a second rail portion coupled to a bracket configured to hold a louver. The second rail portion can couple to the first rail portion in different positions, each having a different distance between the bracket and the mounting structure connected to the first rail portion.

### RELATED APPLICATIONS

This application claims priority to U.S. Provisional Application No. 61/596,175, filed Feb. 7, 2012, and U.S. Provisional Application No. 61/710,550, filed Oct. 5, 2012, both of which are incorporated by reference herein.

### TECHNICAL FIELD

This disclosure relates generally to louver assembly.

### BACKGROUND

Jalousie windows and doors include frames that can tilt louvers open or shut in unison, which can help control airflow through the windows. The frames typically include slots positioned to allow the louvers to slightly overlap adjacent louvers when shut. In conventional jalousie windows, this slight overlap when the louvers are shut provides the sole defense to water, debris, and insect infiltration, which is to say, that conventional jalousie windows fail to prevent water, debris, and insects from entering through the windows.

The slots in the jalousie frames are typically open at one end or include a pinched bracket to hold the louvers, which poses a security risk, as unauthorized removal of the louvers can easily occur from the exterior of the structure. The design of the open ended slots and pinched bracket also has inherent positioning and rotational limitations, as over-rotation or a non-vertical orientation of the frame can cause gravity to pull the louvers of the slots, limiting the prior jalousie frames to vertical implementations.

### DESCRIPTION OF THE DRAWINGS

FIGS. 1A, 1B, and 1C are diagrams of a louver assembly according to embodiments of the invention.

FIGS. 2A, 2B, 2C and 2D are diagrams depicting brackets and a rail in the louver assembly shown in FIGS. 1A-1C.

FIGS. 3A, 3B and 3C are diagrams depicting an example mechanical system for the rail system in the louver assembly shown in FIGS. 1A-1C.

FIGS. 4A and 4B are diagrams depicting example configurations of the rail system shown in FIGS. 1A-1C.

FIG. 5 is a flow chart of a sample method for creating a louver assembly.

### DETAILED DESCRIPTION

As described above, previous jalousie frames are limited to vertical applications and fail to prevent water, debris, and insect infiltration, and unauthorized or unwanted removal of louvers. This application discloses a louver assembly having a bracket system to lock louvers between rails allowing for increased louver rotation and added flexibility of the louver assembly orientation, such as a horizontal or other non-vertical implementation. The louver assembly can further include an integrated seal system, which can provide a water resistant surface when the louver assembly is in a closed position, and include an adjustable rail system allowing for ease of installation. Embodiments of the louver assembly are shown and described below in greater detail.

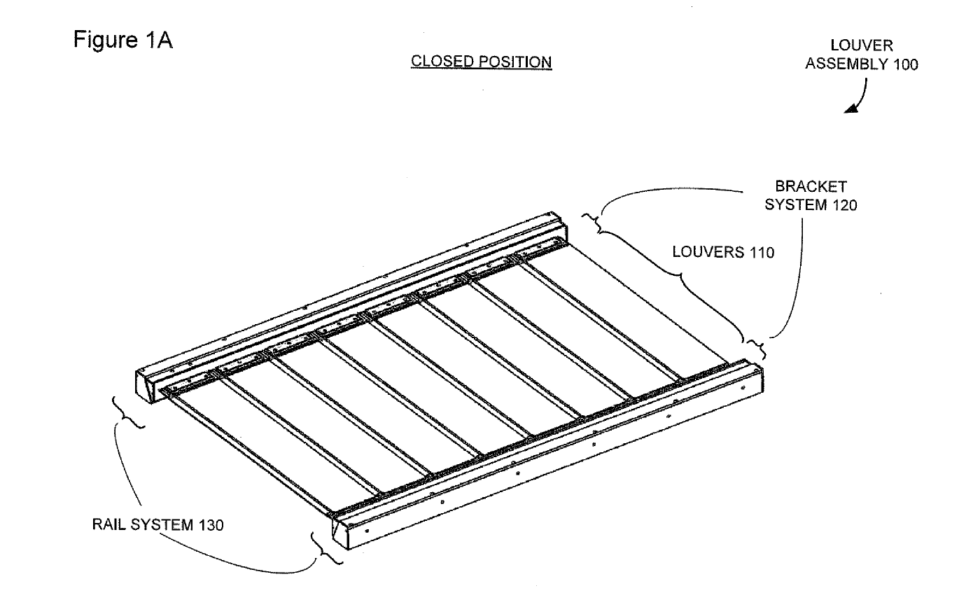

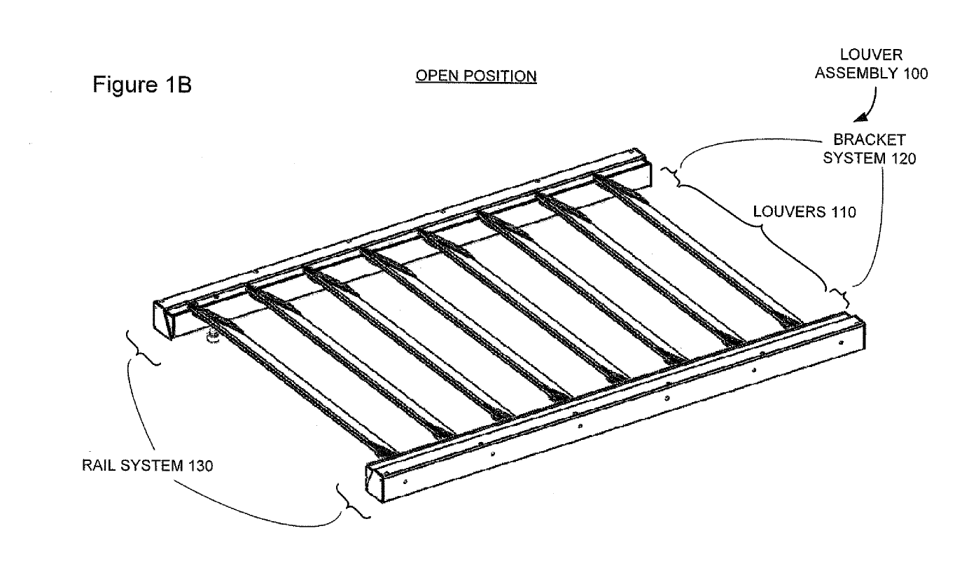

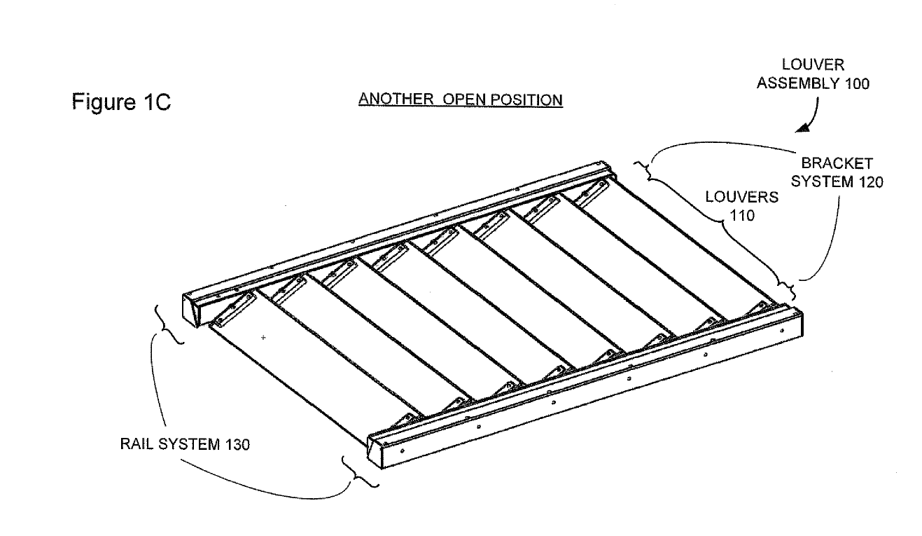

FIGS. 1A-1C are diagrams of a louver assembly 100 according to embodiments of the invention. Referring to FIGS. 1A-1C, the louver assembly 100 can include a rail system 130 coupled to a bracket system 120, which can hold one or more louvers 110. The rail system 130 can be mounted on a structure or support, such as a window frame, door frame, beams of a pergola, or in a skylight, or any other vertical or horizontal opening, etc. The rail system 130 can include multiple rails coupling with brackets in the bracket system 120, for example, on opposing sides of the louvers 110. The brackets in the bracket system 120 can hold the louvers 110 between the rails in the rail system 130. In some embodiments, as will be described below in greater detail, the brackets can connect to the louvers 110, locking them in the louver assembly from unauthorized removal or inadvertent displacement, for example, in a non-vertical application. Although FIGS. 1A-1C show the rail system 130 including multiple rails coupling to brackets on opposing ends of the louvers, in some embodiments, the louver assembly 100 can include a rail system 130 having fewer rails, such as one rail systems, or more rails, such as three or more rails.

The louvers 110 can be made of various materials, such as glass panels, plastic panels, metal panels, composite-material panels, etc. In some embodiments, the louvers 110 can be solid-core panels, such as those described in U.S. Patent Publication No. 2011/0229663, filed Mar. 17, 2010, which is incorporated by reference herein.

The rail system 130 can house a mechanical system to rotate the brackets in the bracket system 120, and thus rotate the louvers 110 between a closed position, for example, shown in FIG. 1A, and one or more open positions, for example, shown in FIGS. 1B and 1C. In some embodiments, the mechanical system in the rail system 130 can rotate the brackets and corresponding louvers 110 up to 160 degrees, although other rotational magnitudes can be achieved by the mechanical system. Embodiments of the bracket system 120 and the rail system 130 will be discussed below in greater detail.

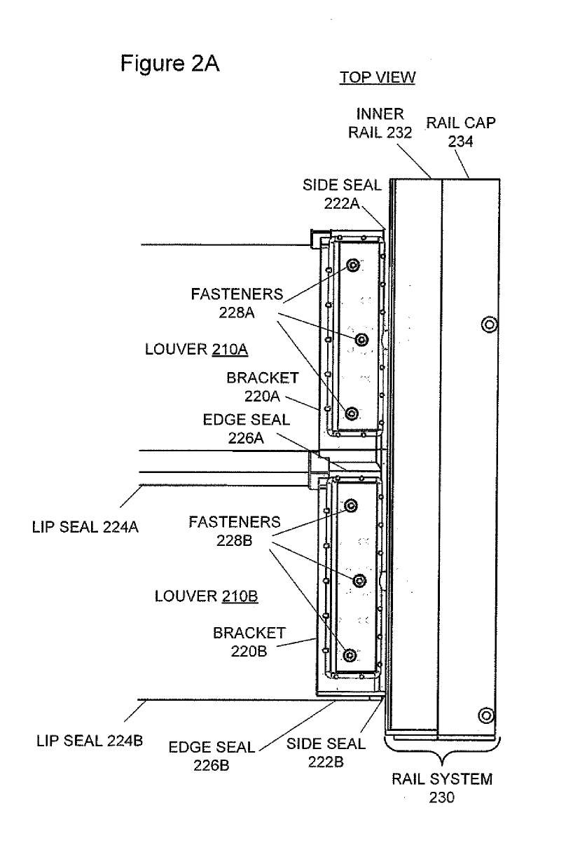

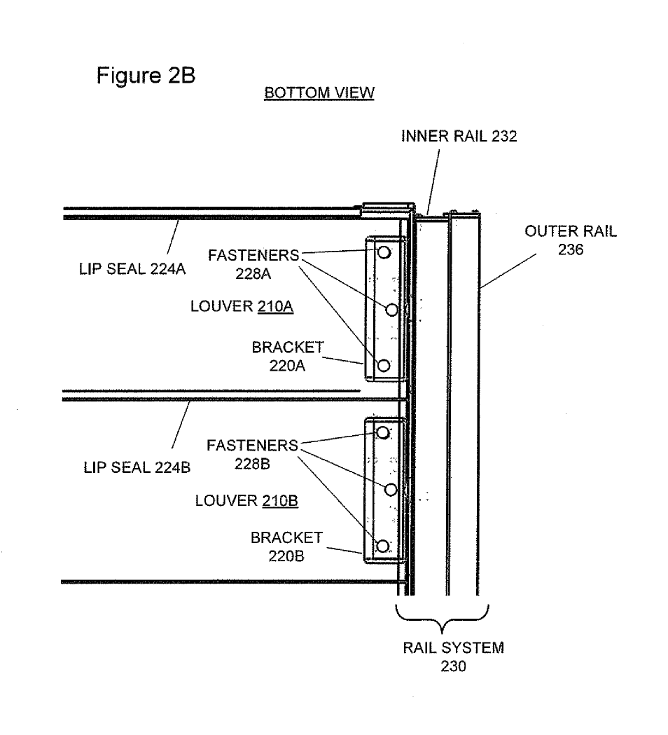

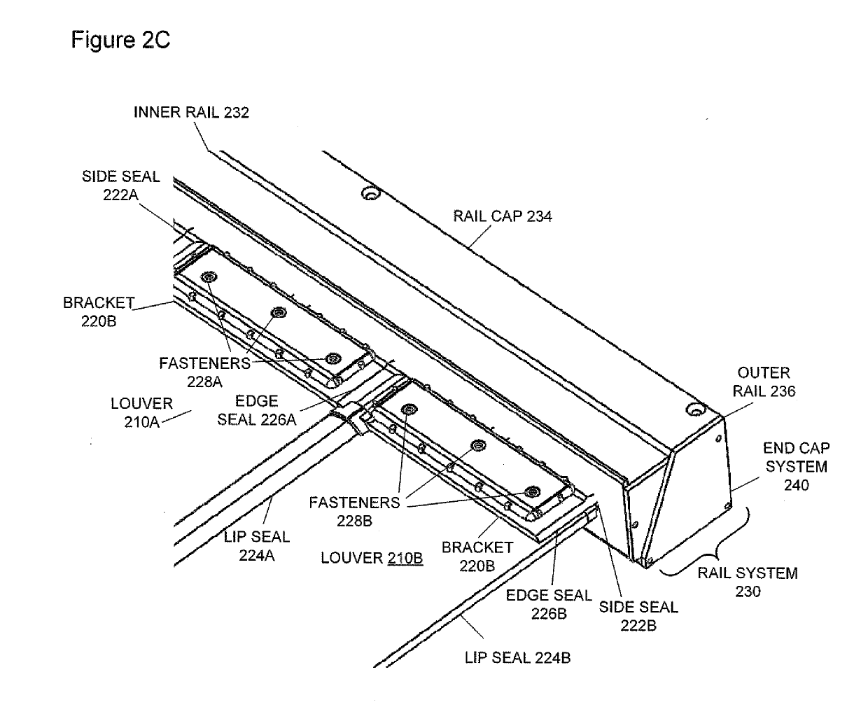

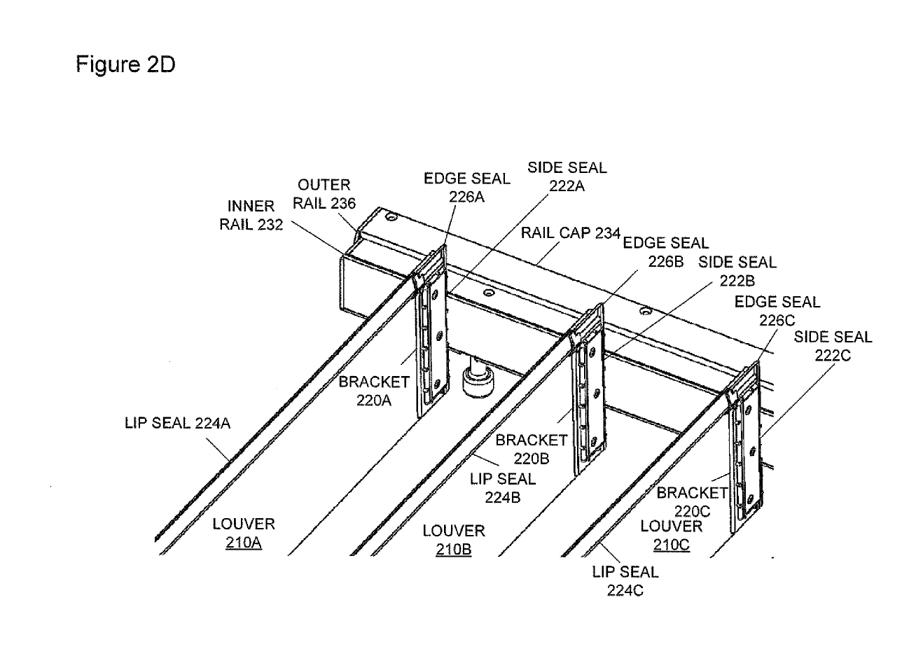

FIGS. 2A-2D are diagrams depicting brackets 220A and 220B and a rail system 230 in the louver assembly shown in FIGS. 1A-1C. Referring to FIGS. 2A-2D, the rail system 230 includes an outer rail 236, which can be mounted on a structure or support, such as a window frame, door frame, beams of a pergola, in a skylight, or any other vertical or horizontal opening, etc.

The rail system 230 can include an inner rail 232 to couple with brackets 220A and 220B, for example, on opposing sides of the louvers 210A and 210B. The brackets 220A and 220B can hold the louvers 210A and 210B, for example, locking them in the louver assembly from unauthorized removal or inadvertent displacement. By locking the louvers 210A and 210B to the brackets 220A and 220B, the louver assembly can be utilized in any orientation, including vertical, horizontal, or other non-vertical orientations, as the louvers 210A and 210B remain secured

The rail system 230 can include a rail cap 234 to couple the inner rail 232 and the outer rail 236 together. In some embodiments, a position of the inner rail 232 relative to the outer rail 236 in the rail system 230 can be varied and the rail cap 234 can lock the position of the inner rail 232 relative to the outer rail 236. This variable positioning of the inner rail 232 relative to the outer rail 236 can allow the rail system 230 the ability to compensate for construction variances in the structure or support, such as in between a window or door frame or between beams in a pergola, or in a skylight, or to compensate for environmental imposed changes to the structural support, such as warping of the structural support over time or expansion and/or contraction due to temperature humidity variances.

In some embodiments, the rail system 230 can include an end cap system 240 including one or more end cap devices, which can couple to the end of the rail system 230, for example, covering an opening at the end of the rail system 230. The end cap system 240 can be made of metal, plastic or other material capable of coupling to the rail system 230.

The brackets 220A and 220B can multiple portions, such as a top portion, for example, shown in FIG. 2A, and a bottom portion, for example, shown in FIG. 2B. The top and the bottom portions of the brackets 220A and 220B can include openings to receive one or more fasteners 228A and 228B, respectively, which can couple the two portions of the brackets 220A and 220B together and to lock a louver 210A and 210B in the brackets 220A and 220B, respectively. The fasteners 228A and 228B can be a screw or other affixing device that can couple the top portion and the bottom portion of the brackets 220A and 220B together. The louvers 210A and 210B can have openings, for example, bore holes in the louvers 210A and 210B, to receive the fasteners 228A and 228B. The openings in the louvers 210A and 210B can corresponding to the openings in the brackets 220A and 220B, which can lock the louvers 210A and 210B to the brackets 220A and 220B, respectively, when the fasteners 228A and 228B couple the top portion and the bottom portion of the brackets 220A and 220B together. This coupling can provide increased security and safety, as the louvers 210A and 210B may not be easily removed from the brackets 220A and 220B by unauthorized users nor would they inadvertently fall out of the brackets 220A and 220B.

The brackets 220A and 220B can have integrated seals, such as side seals 222A and 222B, lip seals 224A and 224B, and edge seals 226A and 226B. The side seals 222A and 222B can couple between the brackets 220A and 220B and the inner rail 232 of the rail system 230, which can keep water and debris from passing through the louver assembly. The side seals 222A and 222B can be made of rubber, plastic, silicon, silia, other elastic, deformable, or compressible material that can form a seal, or other suitable material.

The edge seals 226A and 226B can couple between adjacent brackets and the inner rail. The edge seals 226A and 226B from adjacent brackets can overlap to provide a unitary seal between the brackets 220A and 220B near the inner rail 232 of the rail system 230, which can keep water and debris from passing through the louver assembly. The edge seals 226A and 226B can be made of rubber, plastic, silicon, silia, other elastic, deformable, or compressible material that can form a seal, or other suitable material.

The brackets 220A and 220B and louvers 210A and 210B, respectively, held by the bracket can support the lip seals 224A and 224B, which can run across a long edge of the louvers 210A and 210B. The lip seals 224A and 224B can include a gasket capable of coupling between adjacent louvers, for example, when the louver assembly is in a closed position. The gasket may be a compressible or deformable material, such as plastic, rubber, silicon, silia, etc, that can form a seal between the louvers when the louver assembly is in a closed position. In some embodiments, adjacent louvers 210A and 210B may be positioned to not overlap, allowing the lip seals 224A and 224B couple between and seal the louvers 210A and 210B to create a surface that prevents water or other materials from passing through the louver assembly when in a closed position. By positioning the louvers 210A and 210B in a non-overlapping configuration and attaching the lip seals 224A and 224B to at least one of the louvers 210A and 210B, the louver assembly can form a relatively flat surface (compared to a overlapping louver configuration) in a closed position and still prevent water and debris from passing between adjacent louvers 210A and 210B. The surfaces of adjacent louvers 210A and 210B can be positioned in a common plane when the louver assembly is in a closed position.

In some embodiments, the brackets 220A and 220B also can include a gasket or seal that runs over a surface surrounding the openings. The gasket or seal may keep water and debris from reaching the openings or bore holes in the louvers 210A and 210B and passing through the louver assembly.

The combination of the side seals 222A and 222B, the lip seals 224A and 224B, the edge seals 226A and 226B, and the seal to keep water and debris from reaching the openings or bore holes in the louvers 210A and 210B can allow the louver assembly the ability to create a sealed surface when in a closed position, which can prevent water and debris from passing between adjacent louvers 210A and 210B, between adjacent brackets 220A and 220B, between the brackets 220A and 220B and the rail system 230, and through the openings in the brackets 220A and 220B themselves.

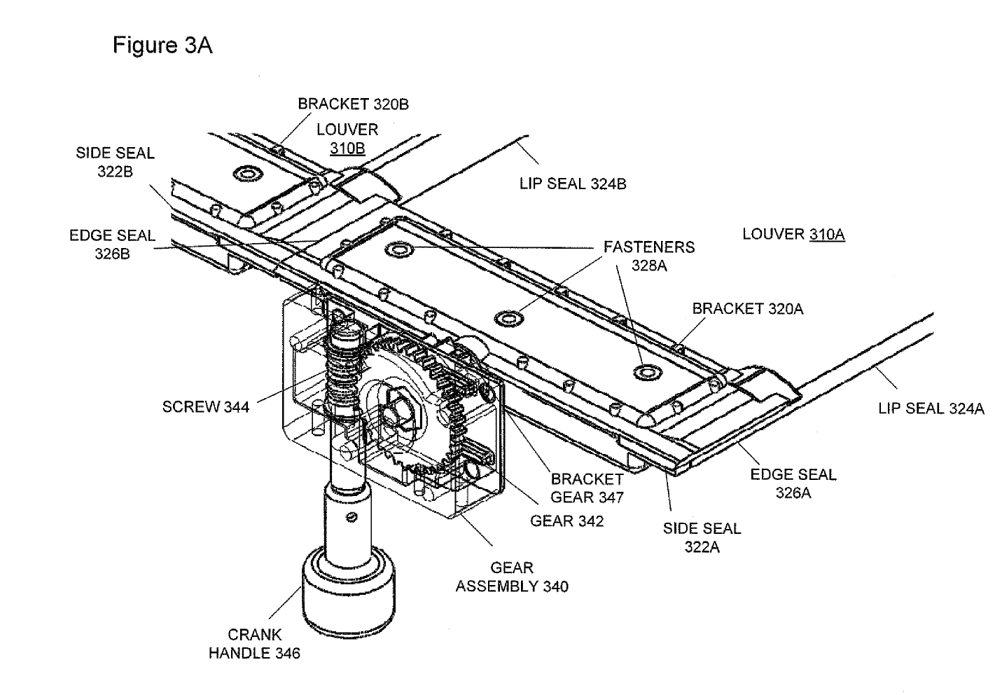

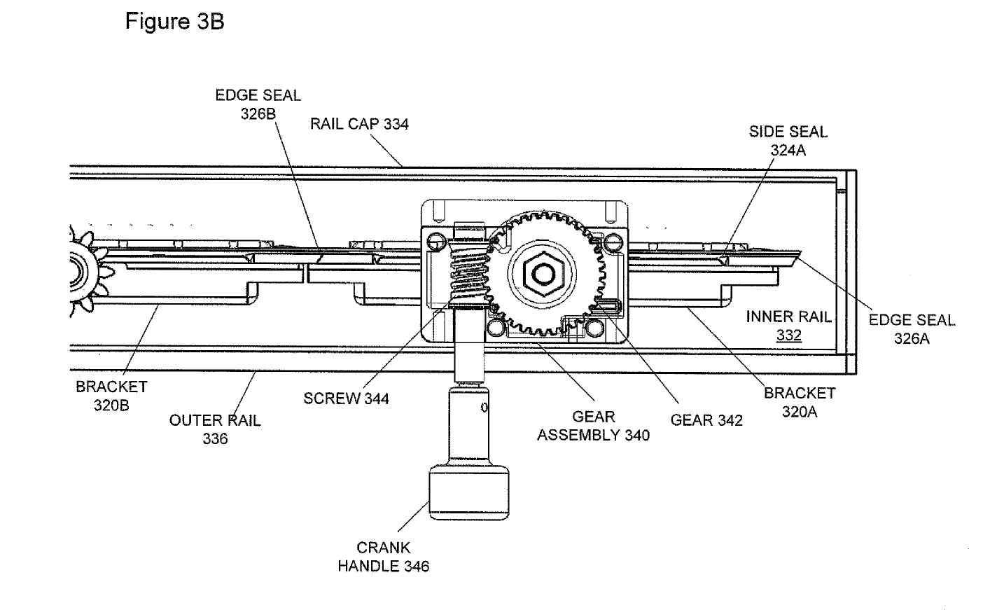

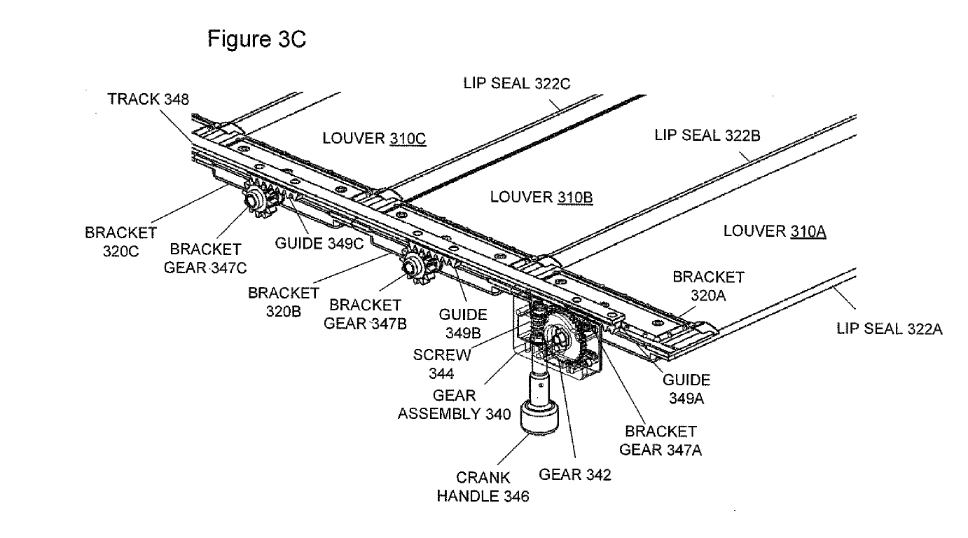

FIGS. 3A-3C are diagrams depicting an example mechanical system for the rail system in the louver assembly shown in FIGS. 1A-1C. Referring to FIGS. 3A-3C, the mechanical system can include a gear assembly 340 and track system including bracket gears 347, a track 348, and guides 349, which can be housed in the rail system 230. The gear assembly 340 can include a gear 342 coupled to a bracket gear 347A. The bracket gear 347A can be coupled to or form a part of the bracket 320A supporting a louver 310A. The bracket gear 347A can rotate based on a rotation of the gear 342, and the bracket 320A and corresponding louver 310A can rotate along with the bracket gear 347A. In some embodiments, the gear assembly 340 can include a screw 344 having threads that can couple to teeth of the gear 342. When a crank handle 346 coupled to the screw 344 is rotated or moved, the screw 344 can rotate, which can rotate the gear 342, the bracket gear 347A, the bracket 320A, and the louver 310A.

The track system can include a track 348 having sections couple to guides 349A-349C. The track 348 can be included within the rail system and span over a length corresponding to multiple brackets 320A-320C coupled to the rail system. The rotation of the bracket gear 347A by the gear assembly 340 can cause the track 348 to move laterally within the rail system. For example, teeth of the bracket gear 347A can couple to a guide 349A of the track 348. As the bracket gear 347A rotates, the guide 349A and track 348 can be laterally moved. The track 348 can include other sections coupled to other guides 349B and 349C. These guides 349B and 349C can couple to other bracket gears 347B and 347C corresponding to different brackets 320B and 320C, respectively. The movement of the track 348 by the gear assembly 340, via the bracket gear 347A, can rotate other bracket gears 347B and 347C corresponding to the brackets 320B and 320C, respectively in the louver assembly. Thus, the gear assembly 340 can rotate all of the louvers 310A-310C in response to a rotation of the crank handle 346. In some embodiments, the crank handle 346 can be replaced with a different manual or machine-operated device, which can rotate the screw 344 and cause the rotation of the gear 342, the bracket gears 347A-347C, the brackets 320A-320C, and the louvers 310A-310C.

The gear assembly 340 can lock the louvers 310A-310C in place by setting a position of the screw 344. Once the position of the screw 344 is set and the louvers 310A-310C locked in position, attempts to move the louvers 310A-310C, for example, by direct rotation of the louvers manually or otherwise, can fail as an attempted rotation of the gear 342 does not rotate the screw 344. In other words, the gear assembly 340 rotates the gear 342 in response to a rotation of the screw 344, but not the other way around, which can help avoid inadvertent rotation of the louvers 310A-310C by unauthorized users or other external forces, such as the wind.

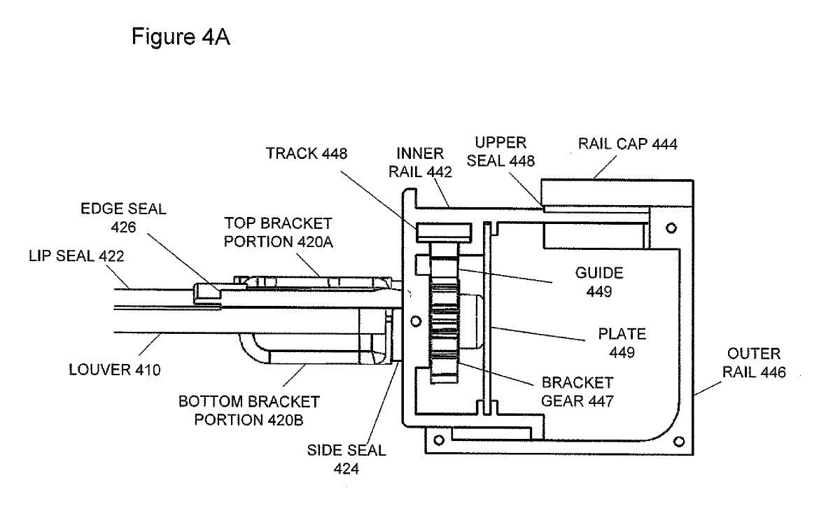

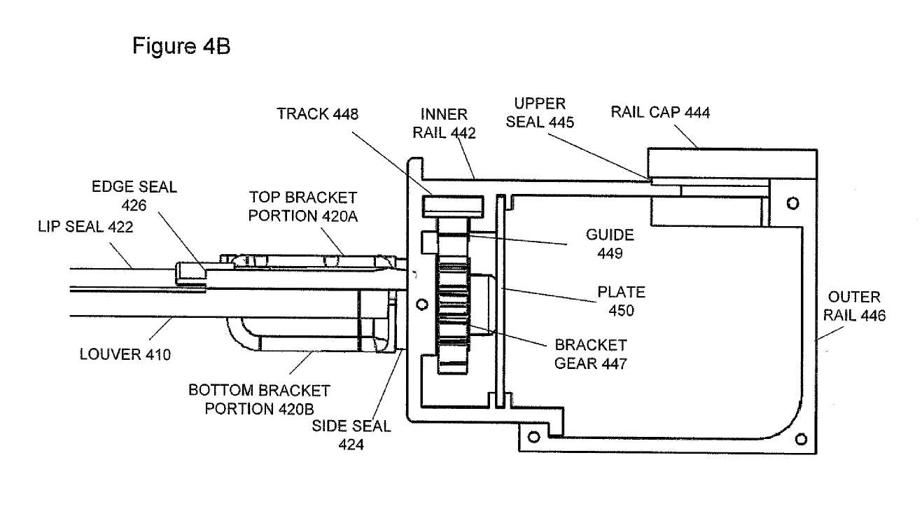

FIGS. 4A-4B are diagrams depicting example configurations of the rail system shown in FIGS. 1A-1C. Referring to FIGS. 4A-4B, the rail system can include an outer rail 446, for example, to mount to a structure or support, an inner rail 442 capable of coupling to the outer rail 446, and a rail cap 444 to couple to a top surface of the outer rail 446, for example, to hold the inner rail 442. The inner rail 442 can be positioned a variable distance at least partially in the outer rail 446, which can allow the rail system the ability to compensate for construction variances in the structural support, such as in between a window or door frame, between beams in a pergola, or in a skylight or to compensate for environmental imposed changes to the structural support, such as warping of the structural support over time or expansion and/or contraction due to temperature humidity variances.

Referring to FIG. 4A, the rail system can be in a first position, for example, with the inner rail 442 positioned to have the bracket portions 420A and 420B and louver 410 close to the outer rail 446. In some embodiments, a top portion of the inner rail 442 can have an end that contact the outer rail 446 in the first position, while a bottom portion of the inner rail 442 can have flange that is separated from a flange of the outer rail 446 in the first position.

Referring to FIG. 4B, the rail system can be in a second position, for example, with the inner rail 442 positioned to have the bracket portions 420A and 420B and louver 410 away from the outer rail 446. In some embodiments, the end of the top portion of the inner rail 442 can separate from the outer rail 446 in the second position, while the flange in the bottom portion of the inner rail 442 can contact the flange of the outer rail 446 in the second position.

The rail system can include various seals that can help to prevent water or other substances from passing from a top surface of the rail system to a bottom surface of the rail system. For example, the rail system can have an upper seal 445, for example, rubber, plastic, silicon, silia, other elastic, deformable, or compressible material that can form a seal, or other suitable material, coupled between the rail cap 444, the inner rail 442, and the outer rail 446. In some embodiments, the rail system can be installed by mounting the outer rail 446 to the structure or support, for example, for both sides of the louver 410, coupling the inner rail 442 to the outer rail 446. The rail system can include the rail cap 444 attached to the outer rail 446, for example, with a screw or other affixing device, which can couple the inner rail 442 within the rail system. In some embodiments, the inner rail 442 can couple to the outer rail 446 by sliding through an opening in the end of the outer rail 446. In some embodiments, the opening can be capped by an end cap system (not shown), which can prevent infiltration of debris, water, or insects into the rail system.

The inner rail 442 can house the bracket gear 447, track 448, and guide 449, and can include a plate 450, for example, to hold the bracket gear 447 in the inner rail 442. The bracket gear 447 can rotate in response to a rotation of a gear in the rail system, for example, either through direct coupling to the gear or through a lateral movement of the track 448 and guide 449 responsive to the rotation of the gear and another bracket guide in the rail system. The bracket gear 447 can couple to the bracket portions 420A and 420B through the inner rail 442, and the bracket portions 420A and 420B can couple to each other and hold the louver 410, for example, with fasteners (not shown). The rotation of the bracket gear 447 can rotate the bracket portions 420A and 420B and louver 410.

The bracket portions 420A and 420B and louver 410 can have corresponding seals, such as the side seal 424, the edge seal 426, and the lip seal 422, which can allow the louver 410, bracket portions 420A and 420B, and the rail system to form a surface in a closed position that can prevent infiltration of water, debris, insects, etc, through portions of the louver assembly.

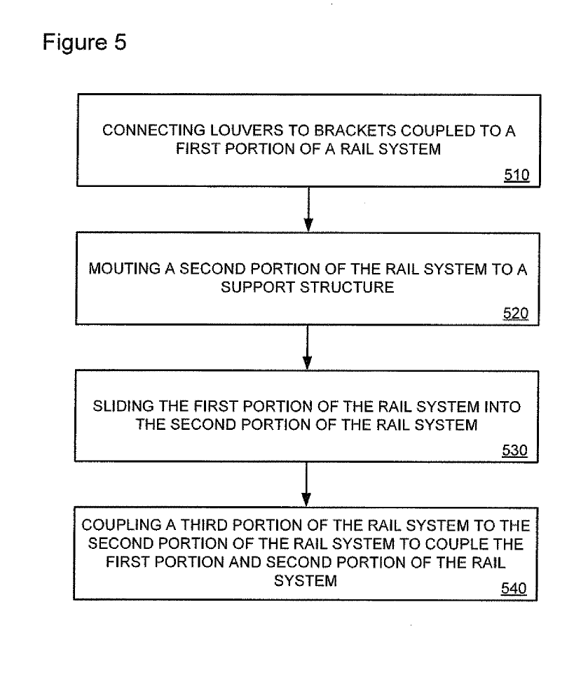

FIG. 5 is a flow chart of a sample method for creating a louver assembly. Referring to FIG. 5, in a block 510, louvers in the louver assembly can be connected to brackets coupled to a first portion of a rail system. In some embodiments, the brackets can include multiple portions, such as a top portion and a bottom portion, which can be positioned on opposite sides of the louvers. The top portion and the bottom portion of the brackets can couple to each other through at least one opening, such as one or more bore holes, in the louvers, which can lock the louvers to the brackets.

In a block 520, a second portion of the rail system can be mounted to a support structure. In some embodiments, the second portion of the rail system can be an outer rail of the rail system.

In a block 530, the first portion of the rail system can slide into the second portion of the rail system. The first portion of the rail system or inner rail along with the brackets and louvers coupled to the first portion of the rail system can slide or be placed on the second portion of the rail system or outer bracket. The first and second portions of the rail system can be configured to allow the first portion of the rail system to be located a variable distance within the second portion of the rail system. This variation in the positioning of the first portion of the rail system can allow the rail system the ability to compensate for construction variances in the structural support, such as in between a window or door frame, between beams in a pergola, or in a skylight or to compensate for environmental imposed changes to the structural support, such as warping of the structural support over time or expansion and/or contraction due to temperature humidity variances.

In a block 540, a third portion of the rail system can couple to the second portion of the rail system to couple the first portion and second portion of the rail system. In some embodiments, the third portion of the rail system can be a rail cap configured to couple to the second portion of the rail system, for example, with a screw or other affixing device. In some embodiments, an end cap can be couple to an end of the rail system to prevent debris, water, and insect infiltration into the rail system.

One of skill in the art will recognize that the concepts taught herein can be tailored to a particular application in many other ways. In particular, those skilled in the art will recognize that the illustrated embodiments are but one of many alternative implementations that will become apparent upon reading this disclosure.

The preceding embodiments are examples. Although the specification may refer to “an”, “one”, “another”, or “some” embodiment(s) in several locations, this does not necessarily mean that each such reference is to the same embodiment(s), or that the feature only applies to a single embodiment.

1. A device comprising:
a rail including a first rail portion configured to connect to a mounting structure, and a second rail portion coupled to a bracket configured to hold a louver, wherein the second rail portion is configured to couple to the first rail portion in different positions, each having a different distance between the bracket and the mounting structure connected to the first rail portion.

2. The device of claim 1, wherein the rail includes a third rail portion configured to couple the first rail portion to the second rail portion.

3. The device of claim 1 further comprising a mechanical system coupled to the second rail portion and configured to rotate the bracket and corresponding louver.

4. The device of claim 3, wherein the mechanical system includes a screw drive coupled to a gear, wherein a rotation of the screw drive is configured to rotate the gear, the bracket, and the louver.

5. The device of claim 1, wherein the bracket includes integrated seals configured to couple between the bracket and the rail, and between the bracket and at least one adjacent bracket.

6. The device of claim 1, wherein the bracket and the louver couple to a lip seal configured to detachably couple to an adjacent louver when the bracket is in a closed position.

7. The device of claim 6, wherein a surface of the louver is positioned in a common plane with one or more other louvers coupled to the rail.

8. A system comprising:
multiple rails connected to a mounting structure; and
multiple brackets coupled to the multiple rails and configured to hold corresponding louvers, wherein each bracket includes a top portion and a bottom portion coupled on different sides of a corresponding louver and connected together with at least one fastener positioned through an opening in the corresponding louver.

9. The system of claim 8, wherein each rail includes a first rail portion configured to connect to the mounting structure, and a second rail portion coupled to one or more of the brackets configured to hold the corresponding louvers, and wherein the second rail portion is configured to couple to the first rail portion in different positions, each having a different distance between the bracket and the mounting structure connected to the first rail portion.

10. The system of claim 9, wherein each rail includes a third rail portion configured to lock the first rail portion to the second rail portion.

11. The system of claim 8 further comprising a mechanical system coupled to the second rail portion and configured to rotate the brackets and the louvers.

12. The system of claim 8, wherein the mechanical system includes a screw drive coupled to a gear, wherein a rotation of the screw drive is configured to rotate the gear, the bracket, and the louver.

13. The system of claim 8, wherein each bracket includes integrated seals configured to couple between each bracket and the rails, and between each bracket and at least one adjacent bracket.

14. The system of claim 8, wherein each bracket and the louvers couple to a lip seal configured to detachably couple to adjacent louvers when the brackets are in a closed position.

15. A method comprising:
connecting louvers to brackets coupled to a first portion of a rail system;
mouting a second portion of the rail system to a support structure;
adjusting a position relative to the support structure for the first portion of the rail system in the second portion of the rail system; and
coupling the first portion of the rail system to the second portion of the rail system at the adjusted position.

16. The method of claim 15 further comprising sliding the first portion of the rail system into the second portion of the rail system.

17. The method of claim 15 further comprising coupling a third portion of the rail system to the second portion of the rail system to couple the first portion and second portion of the rail system at the adjusted position.

18. The method of claim 15, wherein adjusting the position relative to the support structure for the first portion of the rail system in the second portion of the rail system further comprising determining a distance between the brackets and the support structure.

19. The method of claim 15, wherein the second portion of the rail system is configured to couple to the first portion of the rail system in different positions, each having a different distance between the bracket and the mounting structure connected to the first rail portion.

20. The method of claim 15, wherein the brackets include integrated seals configured to couple between the brackets and the first portion of the rail system, between the brackets, and between the louvers.
